(19) United States
(12) Patent Application Publication
(10) Pub. No.: US 2026/0221676 A1
(43) Pub. Date: Jul. 30, 2026

(54) GROUND FOR A UTILITY MARKER POST

(71) Applicant: Christopher Lee Hurt, Stephenson, VA (US)

(72) Inventor: Christopher Lee Hurt, Stephenson, VA (US)

(21) Appl. No.: 19/039,716

(22) Filed: Jan. 28, 2025

Related U.S. Application Data
(60) Provisional application No. 63/626,470, filed on Jan. 29, 2024.

(51) Int. Cl. H01R 4/64; G01C 15/08

(52) U.S. Cl. CPC H01R 4/643; G01C 15/08

(57) ABSTRACT

An electrical ground apparatus that includes a metal sheath affixed to an exterior surface of a hollow pipe, and a metal wire affixed to the metal sheath, and the metal wire is soldered to an exterior surface of the metal sheath and is bent at an angle inward to a hollow center of the plastic pipe and affixed to a jumper junction.

### FIELD OF THE INVENTION

The present invention relates generally to a ground and more particularly a ground designed to provide an earth ground for tracer wires affixed to a utility marker post.

### BACKGROUND OF THE INVENTION

Marker posts are often seen on the sides of roadways and other public areas where utilities are likely to be laid underground. Examples of common types of underground utilities include fiber optic cable, coaxial cable, electrical power cables, gas lines, phone wire, etc.

The marker posts may have their own cables used to support tracing efforts by utility professionals which seek to identify locations of the markers and their respective tracer wires. Some of the marker posts will have tracer wires which run from one marker to another marker underground and can be traced by a tracing device which is a handheld device which applies a radio frequency to the line and provides an analysis regarding the length, location and depth of the line and whether any damage has occurred to the line. Tracer wires may start and stop at each marker post, such that one tracer wire line is strung from a first post to a next post. The tracer wires may be connected to a jumper connector which provides an electrical connection to the next tracer wire which may extend to yet another marker post. The tracer wires may extend in a daisy chain configuration for long distances.

Unfortunately, long wires underground are subject to bleed-off from voltage sources, such as overhead or underground power sources. This may cause the tracer wires to become live wires and to produce a current which could harm a person that comes into contact with the live tracer wires. An independent ground for each marker is the only way to ensure users can be safe when working with a ground marker post.

### SUMMARY OF THE INVENTION

In a first aspect of the present invention, a marker post has a ground which is affixed to an outside of the marker post and which is connected to an internal portion which extends upward towards a jumper junction where the ground can make electrical contact with one or more tracer wires.

One example embodiment may include an electrical ground apparatus that includes a metal sheath affixed to an exterior surface of a hollow pipe, and a metal wire affixed to the metal sheath, and the metal wire is soldered to an exterior surface of the metal sheath and is bent at an angle inward to a hollow center of the plastic pipe and affixed to a jumper junction.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the electrical ground of the present invention.

FIG. 2 depicts a dissected view of the marker post with the electrical ground according to example embodiments of the present invention.

FIG. 3 depicts a dissected view of multiple marker posts with respective electrical grounds according to example embodiments of the present invention.

### DETAIL DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of game apparatuses, embodiments of the present disclosure are not limited to use only in this context.

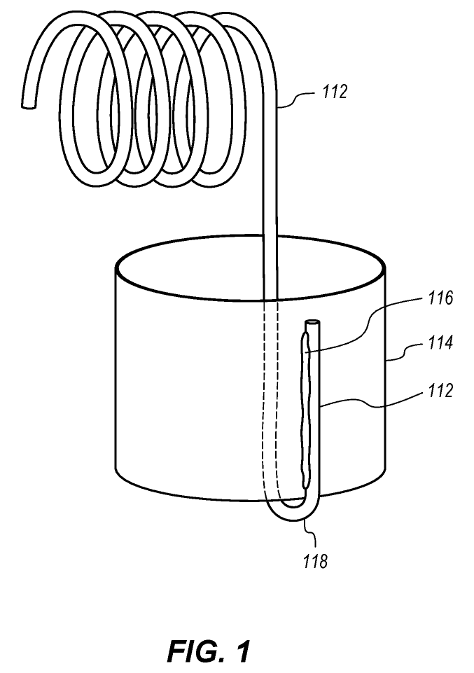

FIG. 1 depicts a perspective view of the electrical ground of the present invention. Referring to FIG. 1, the electrical ground configuration is illustrated as being a standalone device. The ground may include a sheath made of an electrically conductive material such as copper. Other materials may be used which provide an electrical conductor which can ground electricity. The sheath or cuff component 114 may be a thin section of metal that is hollow in the center and which is approximately 1-3 mm (millimeters) in thickness or less. The sheath may be approximately 1-6 inches tall and may be approximately 6 to 18 inches in circumference. The sheath may be a fixed circle, triangle, oval or square and may be closed or come apart and be secured via a latch, Velcro®, a snap button, magnets or other securing elements. The ground wire 112 may be soldered or welded 116 to the exterior or interior portion of the sheath 114. Ideally, the ground wire is also a conductive metal and may be affixed to the outside of the sheath and bent underneath 118 at a junction point and fed upward to traverse the length of the marker post.

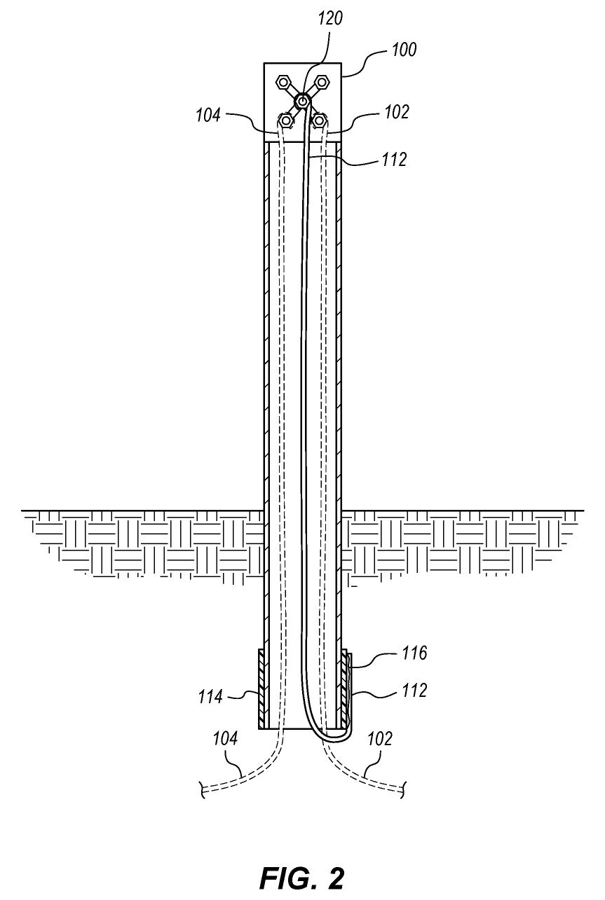

FIG. 2 depicts a dissected view of the marker post with the electrical ground according to example embodiments of the present invention. Referring to FIG. 2, the dissected view illustrates a ground surface by which the marker post 100 is inserted above and beneath the ground surface. The marker post is ideally a plastic material such as polyvinyl chloride (PVC) and has a hollow center where the wires may traverse upwards towards a jumper junction 120 which can provide electrical contact between any of the wires. The ground sheath 114 has the ground wire soldered and/or welded 116 to the outside portion of the sheath. The inside portion of the sheath is firmly affixed against the marker post which tends to be a standard size. As the post is forced into the ground, the tracer wires 102 and 104 may be buried and may be attached to tracer wires of an adjacent post within a distance of the post 100. All wires are shown affixed to securing studs of the jumper junction 120. The ground 112 is in the center of the jumper junction 120, however, any wire may be on any terminal of the junction 120. Each of the wires are disposed upward inside the post and towards the top of the post 120. The post may have a top that is removable (not shown) so the wires can be accessed and tested via a tracer device. The ground 112/114 will protect a user from unexpected voltages which may build up on the tracer wires 102/104.

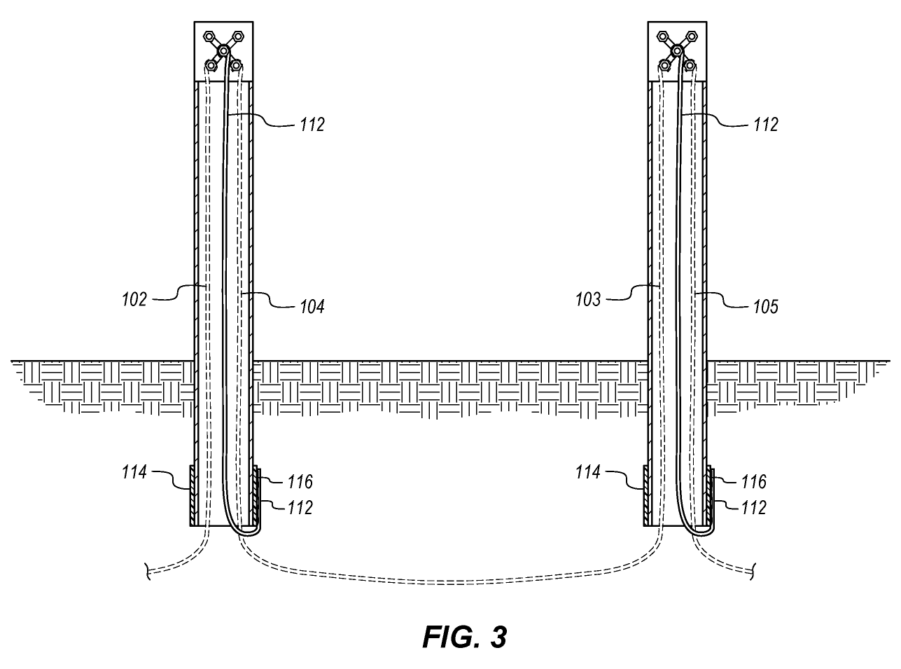

FIG. 3 depicts a dissected view of multiple marker posts with respective electrical grounds according to example embodiments of the present invention. Referring to FIG. 3, the illustration includes two posts where a tracer wire 103 from a first ground is part of a tracer wire configuration 104 of the next ground post. The first post has an incoming tracer wire 105 affixed to the jumper junction 120. The first post also has an outgoing tracer wire 103 which is the same as the incoming tracer wire 104 of the next post, which has an outgoing tracer wire of 102. The posts may be in a daisy chain configuration that includes one, two or many posts along a roadway or other area of interest. Each post should have its own ground configuration including a wire 112 and a ground contiguous sheath 114 that grounds out the voltages which may build on the tracer wires.

The pipe is a non-conductive plastic pipe. In one example, a device may include a hollow plastic pipe and a metal sheath affixed to an exterior of the hollow pipe and where a metal wire affixed to the metal sheath, where the metal wire is soldered or welded to an exterior surface of the metal sheath and is bent at an angle inward towards a hollow center of the plastic pipe and affixed to a jumper junction that is mounted inside the plastic pipe. The pipe may include one or more additional wires affixed to the jumper junction, and the one or more additional wires extend down a length of the hollow plastic pipe. The pipe is plastic and non-conductive. The metal sheath has a smaller depth than a depth of the plastic pipe, the sheath may be approximately 1 mm and the pipe may have a depth of 3 or more millimeters. The metal sheath, once placed outside the pipe, may occupy between two and six inches of height of the plastic pipe which is three feet or more in height. In one example the pipe is seven feet tall and is buried in the ground. Approximately two feet of the pipe is buried in the ground beneath the surface of the ground.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. An apparatus comprising:
a hollow plastic pipe;
a metal sheath affixed to an exterior of the hollow pipe; and
a metal wire affixed to the metal sheath, wherein the metal wire is soldered to an exterior surface of the metal sheath and is bent at an angle inward to a hollow center of the plastic pipe and affixed to a jumper junction.

2. The apparatus of claim 1, comprising one or more additional wires affixed to the jumper junction, wherein the one or more additional wires extend down a length of the hollow plastic pipe.

3. The apparatus of claim 1, wherein the pipe is plastic.

4. The apparatus of claim 1, wherein the metal sheath has a smaller depth than a depth of the plastic pipe.

5. The apparatus of claim 1, wherein the metal sheath occupies between two and six inches of height of the plastic pipe which is three feet or more in height.
